(19) United States
(12) Patent Application Publication
(10) Pub. No.: US 2013/0006801 A1
(43) Pub. Date: Jan. 3, 2013

(54) SYSTEMS AND METHODS ALLOCATING ITEMS AMONG AUCTION SITES TO MAXIMIZE PROFIT

(75) Inventors: Soren Solari, Solana Beach, CA (US); Jacob Spoelstra, Carlsbad, CA (US); Qi Zhao, San Diego, CA (US)

(73) Assignee: Opera Solutions, LLC, Jersey City, NJ (US)

(21) Appl. No.: 13/586,504

(22) Filed: Aug. 15, 2012

Related U.S. Application Data
(63) Continuation-in-part of application No. 13/048,402, filed on Mar. 15, 2011.

(51) Int. Cl. G06Q 30/08

(52) U.S. Cl. 705/26.3

(57) ABSTRACT

A method for allocating vehicles to auction sites. An inventory database stores information uniquely identifying a plurality of items and associating each of the items with one of a plurality of available auction sites. Constraints relating to the movement of the items are stored in a constraints database. Items are identified which are available to be moved from a current location to one of the auction sites. A profit value is estimated for each available move. A move is identified for one item having a highest estimated profit above an identified threshold and meeting related constraints. This move is selected, and profits are reestimated for remaining items to be moved. The selection steps are repeated until no remaining available moves are feasible according to the threshold and constraints. Once all feasible moves have been selected, information associated with the items and moves is transmitted to a client device.

### RELATED APPLICATION

This application is a continuation in part of U.S. application Ser. No. 13/048,402, filed Mar. 15, 2011, entitled “Computer-Based Method and Computer Program Product for Setting Floor Prices for Items Sold at Auction”, which is hereby incorporated by reference in its entirety herein.

### FIELD OF THE INVENTION

The present application is directed to a computerized method for allocating items, and in particular, to computerized method for allocating vehicles among a number of vehicle auction sites to maximize profits from vehicle auction sales.

### BACKGROUND OF THE INVENTION

Auctions are often used as a means for selling significant inventories of items held by a seller. For example, a typical manufacturer of vehicles such as a major automobile manufacturer may over time accumulate a large number of excess vehicles, including fleet vehicles, retail vehicles, company vehicles, off-lease vehicles, and the like. The manufacturer may seek to sell many of these excess vehicles at an auction, with the objective to maximize profit.

Manufacturers will wish to allocate vehicles to particular auction sites which can generate a high sales price while minimizing costs. For instance, vehicles with 4-wheel drive may command better prices in snow regions than in non-snow regions. Costs may include vehicle transportation costs (which can depend, for example, on the number of vehicles being transported to an auction site and whether the transporting vehicle's capacity is full), and depreciation and capital costs (for example, as a function of time lost when the vehicle is being transported and time lost until the vehicle is auctioned).

Two complications arise, however, in determining the proper vehicle allocation:
1) accurately estimating vehicle price generally according to the auction site, and
2) understanding how the characteristics of other vehicles on sale at an auction site at the same time may affect the price of an additionally allocated vehicle.

Typically, decisions to allocate vehicles are based on human judgments; however, these judgments are often made devoid of any reliable means to estimate price for vehicles according to auction site location and according to vehicle inventory at the auction site location. These circumstances may for example cause the seller to lose potential profit in allocating vehicles to the wrong auction sites and/or failing to allocate vehicles at all. Accordingly, there is a need for a method and computer program product that can solve the above problems.

### SUMMARY OF THE INVENTION

The present invention is directed to a computer method for allocating items (for example, vehicles) to be sold at auction among a plurality of auction sites to maximize profit. In accordance with this method, an inventory database stores information uniquely identifying a plurality of items and associating each of the items with one of the plurality of available auction sites or another holding site as a current location. Constraints relating to the movement of the items to other available auction sites are stored in a constraints database. Items are identified which are available to be moved from a current location to one of the auction sites. A profit value is estimated for each available move. A move is identified for one item as having a highest estimated profit above an identified threshold and meeting related constraints. This move is selected, and profits are reestimated for remaining items to be moved. The selection steps are repeated until no remaining available moves are feasible according to the threshold and constraints. Once all feasible moves have been selected, information associated with the items and moves is transmitted to a client device.

### BRIEF DESCRIPTION OF THE DRAWINGS

The invention will become more readily apparent from the Detailed Description of the Invention, which proceeds with reference to the drawings, in which:

FIG. 1 illustrates a flow chart of a vehicle allocation method in accordance with an embodiment of the present invention;

FIG. 2 shows a sample embodiment of a vehicle sales price curve influenced by seasonality;

FIG. 3 illustrates a schematic diagram of a server-based system for carrying out the method for vehicle allocation of FIG. 1;

FIG. 4a shows an illustrative vehicle inventory file according to the method of FIG. 1;

FIG. 4b shows an illustrative constraints file according to the method of FIG. 1;

FIG. 4c illustrates an illustrative shipping file according to the method of FIG. 1;

FIG. 4d shows an illustrative allocation file according to the method of FIG. 1;

FIG. 5 illustrates an illustrative computer system for implementing the server-based system of FIG. 3.

FIG. 6 presents a graphical depiction of a method for determining a fair market price P₀ for a vehicle according to principles of the present invention;

FIG. 7 presents a flow diagram illustrating a process for computing the fair market price according to the method depicted in FIG. 6;

FIG. 8 presents a flow diagram illustrating a process for updating a model used to compute the fair market price according to the method depicted in FIG. 6; and

FIG. 9 presents a schematic diagram illustrating an exemplary system suitable for implementing the method of FIG. 6.

### DETAILED DESCRIPTION OF THE INVENTION

Reference will now be made in detail to exemplary embodiments of the invention. Examples of these exemplary embodiments are illustrated in the accompanying drawings. While the invention is described in conjunction with these embodiments, it will be understood that it is not intended to limit the invention to the described embodiments. Rather, the invention is also intended to cover alternatives, modifications, and equivalents as may be included within the spirit and scope of the invention as defined by the appended claims.

In the following description, specific details are set forth in order to provide a thorough understanding of the present invention. The present invention may be practiced without some or all of these specific details. In other instances, well-known aspects have not been described in detail in order not to unnecessarily obscure the present invention.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this invention belongs.

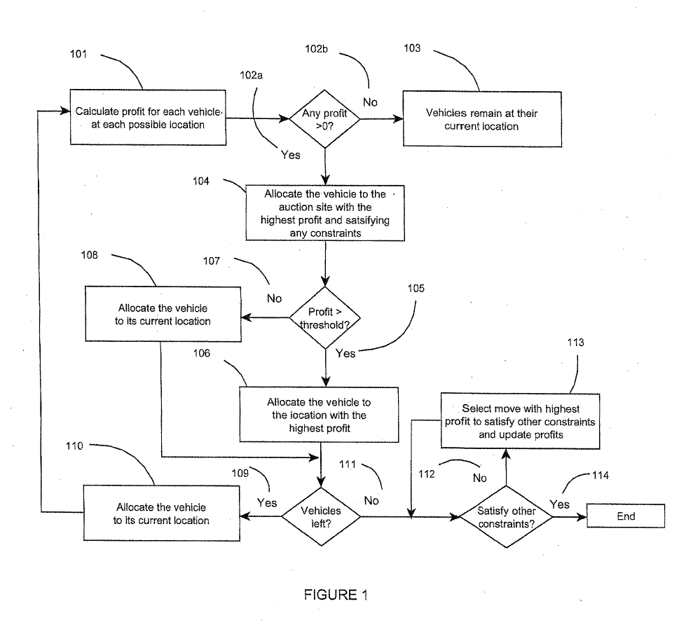

Before discussing the exemplary embodiments in FIGS. 1-9, information on the modeling problem to-be-solved will be provided. The desired vehicle allocation model is a constrained optimization problem to maximize the overall profit in real time while satisfying constraints. If the profit associated with sending each vehicle to each possible auction site is known, then the problem to-be-solved can be formulated as a nonlinear integer programming problem. Assume that there are N transferable vehicles at M auction sites, and they need to be shipped to these M auction sites to maximize the profit due to different auction prices. To simplify the problem, let us consider the M sub-problems: for each Auction site a, how to ship Nₐ vehicles from Auction site a to M Auction sites, where

$${\sum }_{a}^{ } {N}_{a} = N$$

The goal is to maximize the following objective function with {0, 1} variables:

$$f = {\sum }_{i = 1}^{{N}_{a}} {\sum }_{j = 1}^{M} {p}_{ij} {x}_{ij} - {\sum }_{j = 1}^{M} {r}_{j} \cdot ceil ( {\sum }_{i = 1}^{{N}_{a}} {s}_{i} {x}_{ij} )$$

$$s . t . {\sum }_{j = 1}^{M} {x}_{ij} = 1 and {x}_{ij} ∈ \{ 0 , 1 \} ∀ i$$

where, xᵢⱼ is the variable to indicate vehicle i is shipped to auction site j, pᵢⱼ is the price differential for vehicle i between auction sites a and j, rⱼ is the truck load rate from auction site a to site j, ceil(x) (which is called ceiling function) is the smallest integer not less than x, and sᵢ is the size of vehicle i.

In this manner, the profit may be calculated as the price difference minus the costs for each allocation or move. The costs (e.g., shipping costs and capital cost such as vehicles sitting in inventory) are relatively straightforward to estimate. However, there are several challenges to solving this optimization problem with regard to the price. Generally, an auction pricing model can accurately price the vehicle to about twenty days into the future. Pricing accuracy degrades the further out in the future the sale may occur. For the allocation problem, vehicles may sit on the auction lot for up to 3 months before being put up for sale to clear out existing inventory at some locations. Hence, price is preferably modified to factor in vehicle depreciation during this waiting time.

Further, due to the price elasticity of demand, the expected price (and hence profit) also varies with the inventory at each location. For example, a greater number of the same vehicles at the same auction site will tend to reduce prices. The price estimate should take into account this elasticity, but as allocation changes the inventory (thus changes the price and accordingly the profit), the optimization solution has to be dynamic, that is, adjust the price at a particular auction site based on vehicles being allocated to that location.

To address these challenges, the optimization problem should be sequentially solved (i.e., sequentially allocating the vehicle with the largest profit, and dynamically adjusting the price and profit of prior allocations before the next auction site move). This method finds a good global maximum approximation.

A set of business constraints to be satisfied are provided during optimization. The business rules can set maximum and minimum quotas to be shipped to specific locations. In the present case, the constraints are shown as below:

$${\sum }_{i = 1}^{{N}_{a}} g ( {x}_{ik} ) \leq {b}_{k}$$

$$and$$

$${\sum }_{i = 1}^{{N}_{a}} g ( {x}_{ik} ) \geq {c}_{k}$$

where bₖ and cₖ are the maximum and minimum quotas for auction k, and

$$g ( x ) = \{ \begin{matrix}1 , & x ∈ \{ type \} \\ 0 , & else\end{matrix}$$

is the membership function.

With the sequential optimization method, these constraints can be easily checked and satisfied. In practice, a vehicle manufacturer allocates a number of days for assigning the vehicles to their target location, so they have enough time to ship full or almost full loads. Hence the ceiling function can be relaxed to an identity function.

For the purpose of illustrating the present invention, exemplary embodiments, which described the specifics of the modeling solution, will be described with reference to FIGS. 1-9.

Exemplary Vehicle Allocation Method

FIG. 1 illustrates a flow chart in accordance with one embodiment of the vehicle allocation system. A profit for each vehicle at each location is calculated at step 101 based on the price difference between expected vehicle price at the destination auction site and expected price at an origin (auction site or holding site) minus any costs, as shown in equation (1) below.

Profit=Expected Price_{D}−Expected Price_{O} (1)

The expected price at the destination is a function of the expected sales date, which is the allocation date (e.g., when the vehicle would be transported to the destination auction site) plus any waiting times as shown in equation (2) below. The expected price at the origin site may be previously determined, or in the case of a holding site where the vehicle cannot be sold, may be deemed as having a de minimis or zero value.

Expected Sales Date=Allocation Date+Waiting Times (2)

The waiting times in equation (2) may include or be based on the following:
i. Shipping Time: The shipping time from original auction site to the destination auction site. This can be estimated, for example, as a function of the distance between the destination and origin sites.
ii. Destination Inventory Time: The waiting time due to the destination location having an inventory of vehicles similar to that of the vehicle being allocated or moved. This time may be estimated, for example, by dividing the inventory of similar vehicles by the average sales flow (e.g., estimated based on historical sales data, such as the last 3 months). For example, if you have 10 total 2005 Honda Accords 2.4 LX 4dr Sedan in inventory, and the average sales flow for those vehicles is 2 per week, then the waiting time would be 5 weeks for the 2005 Honda Accords 2.4 LX 4dr Sedan to be sold.
iii. Destination Auction Date: As each auction site may have its own calendar for events (e.g., at some locations auctions are held once a week), in calculating the expected sales date, it would be the nearest calendared date after the total waiting time calculated based on the (i) shipping time and (ii) destination inventory time.

Further in accordance with an embodiment of the present invention, once the expected sales date is determined, each vehicle at the destination location can be priced (the expected price for the destination discussed above) using equation (3) below.

|P_{T}=Pₒ×F_{d}×Fₛ (3)

where the price estimate for each vehicle at each potential destination auction site at the current time is denoted as Pₒ, depreciation is denoted as F_{d}┐ (e.g., vehicle depreciation as time passes), seasonality (e.g., vehicle prices rise and fall seasonally throughout the calendar year) is denoted as Fₛ┘, and each vehicle's adjusted price is denoted as P_{T}┘.

The first variable, Pₒ, which may also be referenced herein as a “fair market price” or a “floor price,” may be calculated for example using a market-based vehicle pricing model described further herein in the section entitled “EXEMPLARY METHOD FOR CALCULATING MARKET-BASED PRICE P₀.”

Depreciation ( F̅_̅{̅d̅}̅) may be calculated, for example, by assuming it is exponential over time at a monthly rate (r) (e.g., 1.25%) as illustrated below in equation (4):

F_{d}=(1−0.0125)^{#months}| (4)

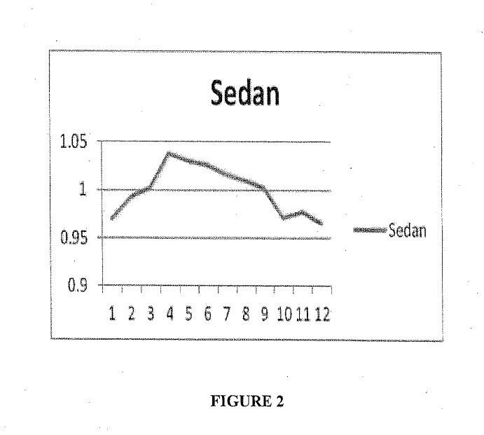

Seasonality (|Fₛ) may, for example, be determined based on empirical data (see, e.g., FIG. 2). Such empirical data is preferably provided by vehicle type (e.g., Truck/SUV, Sedan) and more preferably by vehicle model along with the drive train and contain data for a selected number of years (e.g., past 10 years) and continuously updated.

After determining the expected vehicle price at the destination site, costs are calculated in order to arrive at a profit. For example, in allocating a car to another auction site, shipping costs will be incurred. These costs may likely be determined (if not actually billed) as a function of vehicle size and the distance between the origin site and destination auction site. In addition, capital costs (e.g., costs incurred while holding vehicles in inventory prior to sale) may for example be determined using a simple interest rate calculation (e.g., 0.375% per annum). In a preferred embodiment, the capital costs are absorbed into the price depreciation equation (4) discussed above.

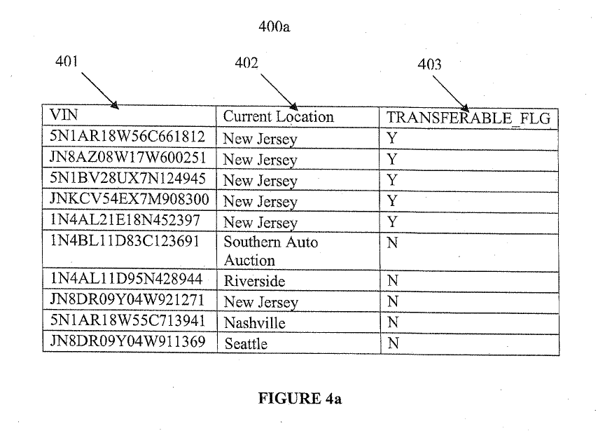

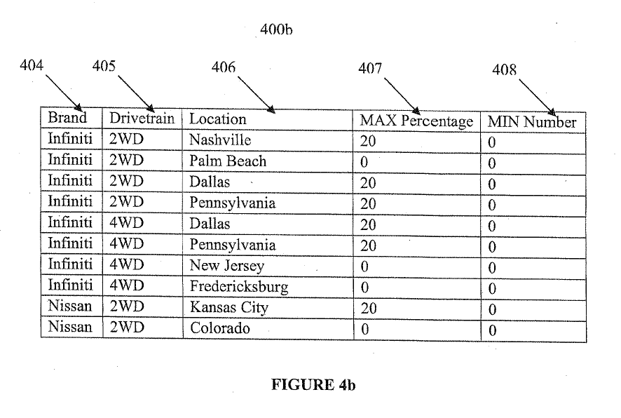

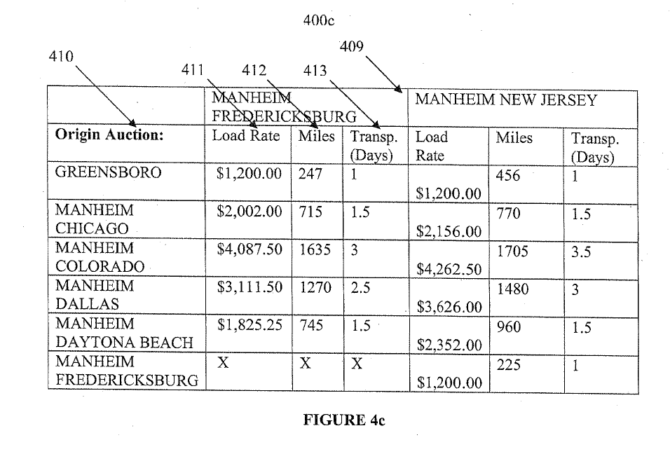

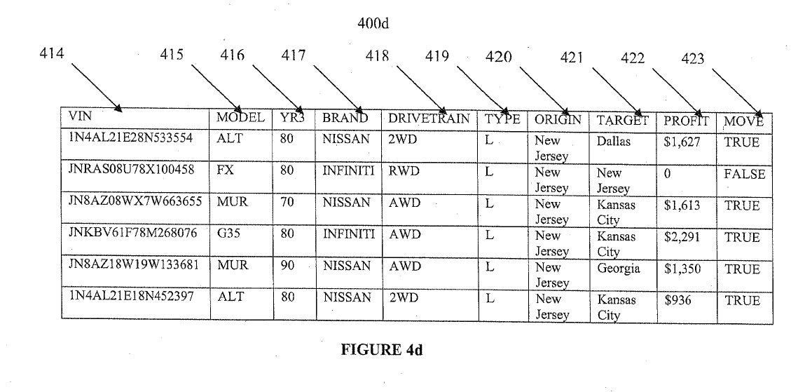

Based on the above vehicle calculations, if it is determined that no profit exists at step 102b of FIG. 1, then a vehicle would remain at its current location according to step 103. If there is profit as determined at step 102a, then a destination auction site is selected for the vehicle based on the profit and according to constraints at step 104 (e.g., the constraints may provide for a minimum and/or maximum number of vehicles to be allocated per auction site as discussed below in reference to FIG. 4b). This is done by selecting one or more auction sites that satisfy the constraint(s) and have a profit above a predetermined threshold at steps 104, 105. If no vehicle has sufficient profit and has satisfied the constraints at step 107, the vehicle remains at its current location as determined at step 108.

If movement to one or more auction sites satisfies the constraints and have sufficient profits, the move with the highest profit is chosen at step 106. After allocating the vehicle (whether to its current location or by movement another location based on profit and constraints), it is determined whether there are any vehicles left. If yes, at steps 109, 110, the process returns to step 101 as described above to dynamically update the prices Pₒ and recalculate the potential profits for each possible move.

As a part of the process of dynamically updating the price due to the allocation (or stay) of a vehicle 110, price elasticity may preferably be modeled as a price drop of y % per vehicle resulting from the allocation of the vehicle to a particular location having other similar vehicles (e.g., with the same year-model and drivetrain). For example, and assuming that y %=0.25, then let |n| be the number of vehicles (e.g., the same year-model and drive train) that are currently allocated to one location, and ┌P_{T} be the price as determined above. The updated price as a function of price elasticity for a particular auction site from adding a particular vehicle is then calculated as

P̅ₙ̅=̅(̅1̅−̅0̅.̅2̅5̅)̅ⁿ̅P̅_̅{̅T̅}̅ (5)

This value Pₙ is the new price for a particular vehicle at a particular auction site. For example, if a 2005 Honda Accords 2.4 LX 4dr is allocated to an auction site in Atlanta having another 2005 Honda Accords 2.4 LX 4dr in it's inventory, the unallocated price, Pₒ, in equation (3) for the additional 2005 Honda Accords 2.4 LX 4dr is calculated by inserting the value Pₙ for Pₒ in equation (3). The value Pₙ may be further adjusted for various external factors that influence price including, for example, anticipating the price effects of planned new launch of a similar vehicle, planned manufacture incentive programs for similar vehicles, and the like. The value Pₙ may also be further adjusted to account for differences in quality between the allocated vehicle and similar vehicles at the auction site such as based on, for example, condition grade and/or vehicle damage.

These processes of vehicle allocation and price updating continue until it is determined that there are no more vehicles to process at step 111. At steps 112, 114, the allocation result are checked against “minimum” constraints. For example, the auction sites could be required to maintain a minimum number of vehicles in order to carry out an effective auction. If the allocation fails to satisfy the minimum constraints at step 112, potential allocations are evaluated at step 113 (in accordance with the process of step 101) to identify highest profit allocations that satisfy the minimum constraints. When the minimum constraints are fully satisfied, the algorithm completes at step 114.

FIG. 2 shows a sample embodiment of a curve based on seasonality as discussed previously. Specifically, by illustration, it shows over a twelve month period how seasonality (┌Fₛ) changes each year for sedans.

Exemplary Vehicle Allocation System

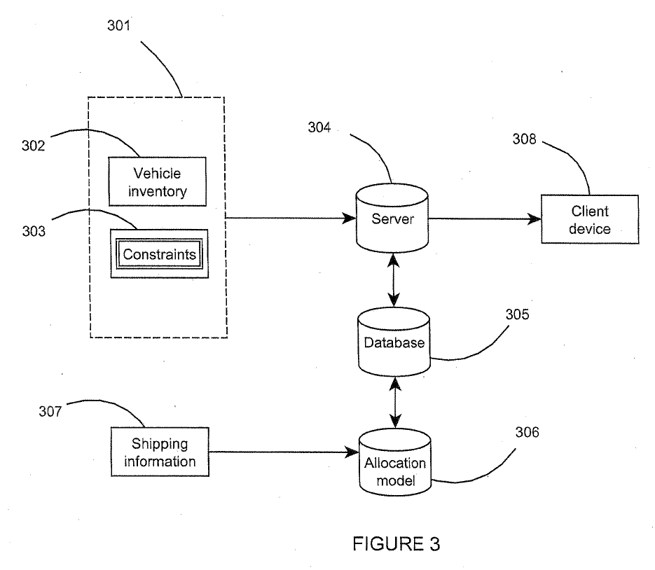

FIG. 3 illustrates an exemplary server-based system for carrying-out the above-described method-based embodiment of the present invention. Input files 301 (e.g., vehicle inventory 302 and constraints 303) are provided to a server 304. The server 304 stores the files in a database 305. This server could be, for example, a secure ftp (sftp) server to securely receive vehicle and constraint data, and provide allocation data securely to a client device. The allocation process described in FIG. 1 and identified as allocation model 306 in FIG. 3 is executed (for example, by an associated server) to access the database 305 to obtain the current inventory for each auction site and determine how the vehicles are to be allocated. Also, the allocation model 306 applies shipping information (e.g., shipping time and cost) which may preferably be obtained from a separate file 307. With all necessary information, the allocation model 306 generates results, writes them into the database 305, and then sends the results back to the client 306 via the server 304. The client device may, for example, be a laptop computer, set-top box, tablet PC, cell phone, smart phone, and/or any other mobile data, messaging, and/or communication device.

Exemplary Data Files

FIG. 4a shows an illustrative inventory file 400a as described in FIG. 3. The file 400a could contain, for example, a Vehicle Identification Number (also known as “VIN”) 401 used to uniquely identify each vehicle. Also included in the file are the current location of the vehicle 402 and a flag (Yes or No) 403 to indicate whether the vehicle can be transferred or allocated to another location.

FIG. 4b shows an illustrative constraint file 400b as described in FIG. 3. The constraints file contains data regarding the maximum or minimum number of vehicles allowed at each auction site. For example, as illustrated in FIG. 4b, the file includes data fields for Brand (e.g., Infiniti) 404, Drivetrain (e.g., 2WD) 405, Location (e.g., Nashville) 406, MAX Percentage (e.g., maximum the number of vehicles per auction site) 407, and MIN Number (e.g., minimum the number of vehicles per auction site) 408.

FIG. 4c illustrates an illustrative shipping information file 400c as described in FIG. 3. In one embodiment, the file could provide shipping information 411-412 and shipping time 413 between two destination auction sites (e.g., Manheim (Fredericksburg) and Manheinm (N.J.) 409) relative to the origin site 410. FIG. 4c includes data fields for the Original Auction Location (e.g., Greensboro) 410 and data for other auction sites (e.g., Manheim Fredericksburg and Manheim N.J.) 409. The data regarding the other sites could include, load rate 411, miles 412, and number of days to transport or shipping time 413.

FIG. 4d shows an illustrative allocation results file 400d as described with reference to FIG. 3. For example, as illustrated in FIG. 4d, the file includes data fields for VIN 414, Model 415, Year 416, Brand 417, DriveTrain 418, Type 419, Origin 420, Target 421, Profit 422, and Move (or allocated) 423.

Exemplary Computer System

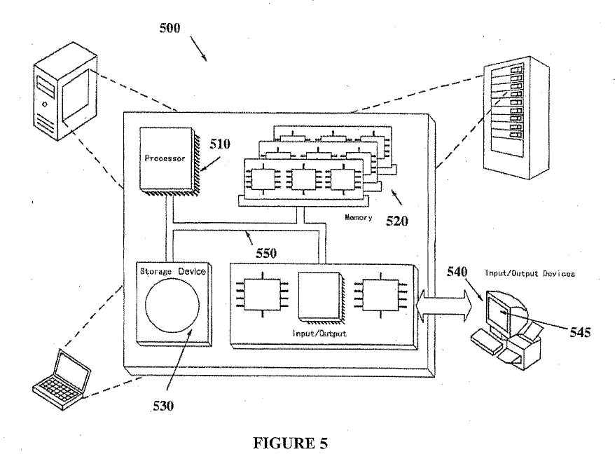

FIG. 5 illustrates a computer system 500 which may be used to implement one or more of the server elements 304, 306 shown in FIG. 3 The computer system 500 as described herein may comprise, for example, a personal computer running the WINDOWS operation system, or a server computer running LINUX or another UNIX-based operating system. The above-described methods of the present invention may be implemented on one or more computer systems 500 as stored program control instructions directed to control application software, for example, including general purpose programming environments such as Python, and database systems such as MySQL.

Computer system 500 includes a processor 510, a memory 520, a storage device 530 and input/output devices 540. One of the input/output devices 540 may include a display 545. Some or all of the components 510, 520, 530 and 540 may be interconnected by a system bus 550. Processor 510 may be single or multi-threaded, and may have one or more cores. Processor 510 executes instructions which in the disclosed embodiments of the present invention comprise steps described in one or more of FIGS. 1-4a-4d. These instructions may be stored in the memory 520, or in the storage device 530. Information may be received and output using one or more of the input/output devices 540.

The memory 520 may store information and may be a computer-readable medium, such as volatile or non-volatile memory. The storage device 530 may provide storage for the computer system 500 including for the example, the previously described database, and may be a computer-readable medium. In various aspects, the storage device 530 may be a flash memory device, a floppy disk drive, a hard disk device, and optical disk device, or a tape device. Input devices 540 may provide input/output operations for the computer system 500.

Input/output devices 540 may include a keyboard, pointing device, and microphone. Input/output devices 540 may further include a display unit for displaying graphical user interfaces, a speaker and a printer. As shown, each computer system 500 may be implemented in a desktop computer, or in a laptop computer, or in a server, typically in communication with the Internet via a local area network (“LAN,” not illustrated). Alternatively, for example and with particular reference to the client devices 308 of FIG. 3, the computer system 500 may be implemented as a “smartphone” mobile communications client device 308 accessed remotely from a wireless link to the mobile communication device.

Exemplary Method for Calculating Market-Based Price P₀

General Considerations for Determining the Floor Price of a Vehicle

Developing an accurate prediction of the floor price of a vehicle is non-trivial problem, as many varied factors may influence the floor price. At a high level, these factors may for example include:
vehicle-specific factors: factors that are determined with reference to a specified vehicle, and may include
   vehicle-specific properties—for example, vehicle manufacturer, make, model, year of manufacture, feature options (for example, trim), vehicle mileage, vehicle condition (including, for example, apparent damage), vehicle color, vehicle identification number (VIN), engine option and fuel performance in miles per gallon (mpg), and a variety of other numerically or categorically expressed features that may be conventionally used to characterize a specific vehicle,
   auction properties: the location of sale of this specific vehicle, and the sale date of this specific vehicle, and
non-vehicle specific factors: factors that may affect the sale price of vehicles and are not directly related to a specific vehicle, for example including: current fuel prices, general economic factors (for example, consumer confidence, consumer sentiment, unemployment, housing prices, stock market, and the like), weather events, news events and the like.

By way of example, Table I provides a preferred list of factors to be considered in modeling reserve price for a vehicle, including an associated data type (“factor type) indicating a data storage mode. This list was assembled, for example, based on (1) vehicle data available for collection and (2) expert judgment. The list was further refined through experimentation and re-evaluation:

TABLE I

| Factor Description | Factor Type |
|---|---|
| Date of vehicle attempted/successful sale | Date |
| Auction Identifier where vehicle is/was sold | Integer |
| Vehicle model | String |
| Model year | Integer |
| Vehicle trim description, e.g. XL | String |
| Drive train description, e.g. 4WD | String |
| Body style description, e.g. Coupe | String |
| Transmission description, e.g. Auto | String |
| Vehicle color code | String |
| Damage amount | Integer |
| Mileage | Integer |
| Vehicle grade (1-5) | Integer |
| Manufacturer's suggested retail price (MSRP) for | Integer |
| original vehicle | |
| Source of vehicle, lease/fleet/credit/company/etc. | String |
| Indicator if vehicle has previously been sold | Boolean |
| Indicator of whether the vehicle was sold or not | Boolean |
| at this event date | |
| Frame damage indicator | Boolean |
| List of all manufacturer options on vehicle (List | String |
| of codes with separator, e.g. A01:B12:B23) | |
| True Mileage Unknown indicator | Boolean |
| Vehicle buy-back indicator | Boolean |
| Normal wear and tear amount | Integer |
| Auction type code, e.g. closed/open/etc. auction | String |
| Repossession indicator | Boolean |
| Final sale price (if sold) | Integer |
| VIN of vehicle | String |

Typically, the seller of a vehicle will be able to directly observe and/or control the vehicle specific factors, while the non-vehicle specific factors, being unrelated to any specific vehicle, may be uncontrollable, unobservable and/or unknown.

In a floor or reserve price model developed in accordance with principles of the present invention, it is assumed that two identical vehicles (in terms of their vehicle specific factors) should effectively share the same fair market value. With this premise in mind, a model developed in accordance with principles of the present invention estimates the difference in price between two vehicles as a function of the price differences attributable to the differences in the features of the vehicles, plus some random fluctuation (noise). Assuming that the actual sale price of a first one of the two vehicles is a suitable proxy for its fair market value, the fair market value of a second vehicle can be determined as a function of the actual sale price of the first vehicle and the functional differences between the two vehicles. Significantly, and as further illustrated below, the effects of relevant non-vehicle specific factors may be implicitly captured in the differences measured among the vehicle-specific factors.

By way of example, consider fuel price as a non-vehicle specific factor which can affect the value of a vehicle. Although fuel price is a factor admittedly not significantly influenced by characteristics of a particular vehicle, an effect of fuel price may never-the-less influence a financial impact for a vehicle-specific feature (for example, a price difference according to fuel performance in mpg).

By comparing the market value of two vehicles having a common value for a vehicle-specific factor (e.g., mpg) that is related to a common non-vehicle factor (e.g., fuel price), the non-vehicle factor can essentially be “normalized” in the sense that it presents no effect on price difference for the two vehicles sharing a common value for the related vehicle-specific feature. Therefore, by comparing sufficiently similar vehicles (at least with respect to vehicle-specific features that are related to non-vehicle specific features), the effects of the non-vehicle specific features can be normalized (or otherwise minimized) such that they have essentially no effect on the operation of the model. As the effects for many non-vehicle specific features may be unknown or otherwise difficult to estimate, this aspect of the present invention is significant.

According to principles of the present invention, a fair market value price model as disclosed herein predicts that “identical” vehicles will have the same fair market value. In order to qualify as being identical, inter alia, the time and location of sale for each vehicle must be coincident. Since no two vehicles can be sold at precisely the same time in the same place, no two vehicles will ever be completely identical. This limitation, however, does not prevent effective application of the fair market value price model.

Applicants note that when the volume of vehicle sales is large (for example, at or above 1000 vehicles per month) and vehicles are sold on a daily, hourly or even per minute basis, vehicles can be compared with each other within a reasonably short time period (for example, within a 50-day window) so long as the final sale prices are available. A comparison however may be reasonably made based on only one other comparable sale during the time period. This is possible for the following reason.

Non-vehicle specific factors are most often economic factors that change at a much slower rate than the rate at which vehicle are sold. Therefore, by comparing the vehicle to be sold with previously-sold vehicles all sold recently (for example, within the 50-day window), the changes due to these non-vehicle specific factors are negligible, and as a result, the effects can readily be normalized. Even if there is an abrupt change in value for a non-vehicle specific factors that significantly affects fair market value, Applicants observe that the change can be quickly normalized by limiting comparisons of the vehicle to be sold to the most recent vehicle sales occurring after the abrupt change, because these most recent sales will have incorporated the abrupt changes implicitly.

Applicants further observe that the function of differences between vehicles is in general non-linear. For example, for two randomly-selected vehicles having varying trim options, mileage, vehicle condition, other options, color, and location of sale, the varying factors may interact in ways that are not accurately modeled as an independent linear sum of the apparent differences. However, by restricting the analysis to a comparison of “most” similar vehicles (as described further herein), Applicants have determined that the analysis can be transformed into a domain where the differences are nevertheless reasonably linear. A key therefore to the analysis carried out in accordance with principles of the present invention is in the selection of substantially similar vehicles (both in features and in time) for comparison, so that non-linear interactions among factors are minimized or otherwise muted, and so that the analysis, in essence, is “linearized.”

Model for Determining the Floor Price of a Vehicle

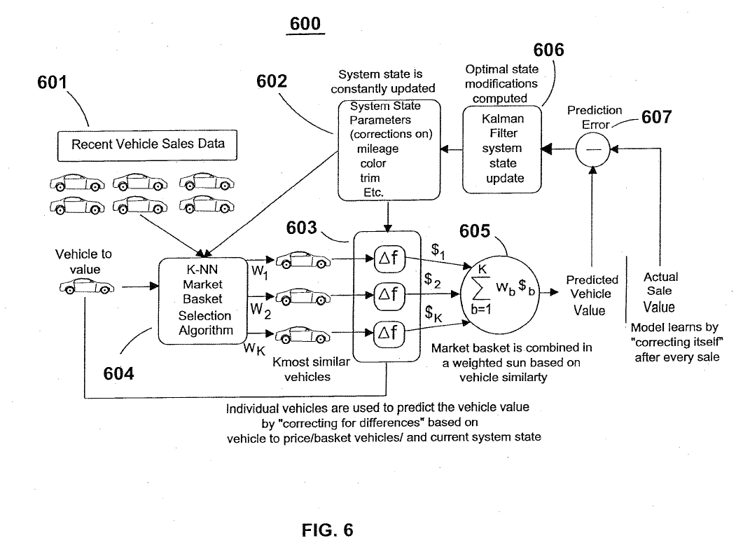

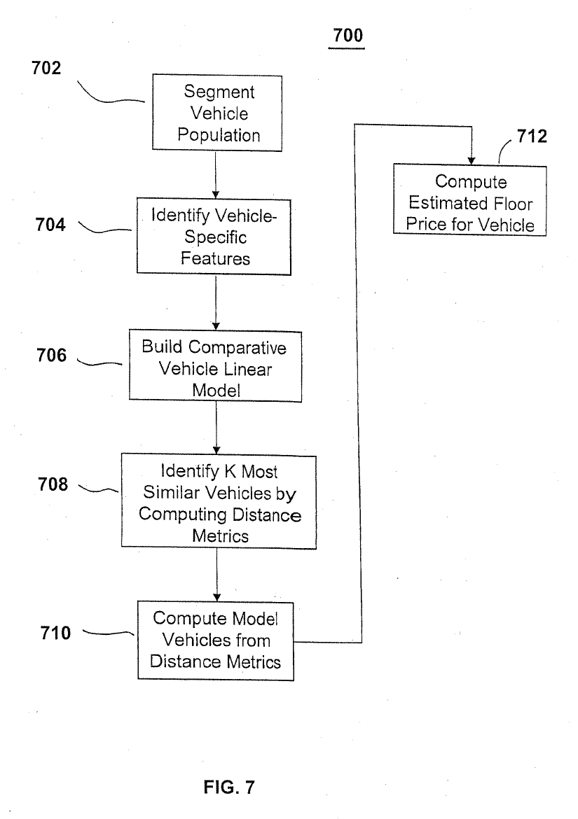

FIG. 6 presents a graphical depiction of a method 600 for determining a fair market price for a vehicle according to principles of the present invention. An exemplary process 700 for computing the fair market price according to the method depicted in FIG. 6 is further illustrated by a flow diagram present in FIG. 7.

At step 702 of FIG. 7, the process 700 begins with a segmentation of the vehicle population into “homogenous” model groups. For example, a preferred vehicle segmentation may group vehicles according to model and production year. However, one of ordinary skill in the art will realize that many other segmentations may also be suitable, provided that the segmentations provide a reasonable number of data samples of vehicles sold at substantially the same time (for example, 1000 or more) in order to adequately enable normalization of non-vehicle specific features as described above.

At step 704, appropriate vehicle-specific features are identified and selected for determining the differences in value between vehicles. This step is further depicted in FIG. 6 by functional element 602. Selected features may be characterized numerically or categorically. In the case of numerical features, for example, each feature will preferably be defined as having a single numerical value (e.g., dollars ($)/accumulated miles). In the case of categorical features, such as the category of vehicle options, each unique feature in the category becomes an independent binary feature of the vehicle (i.e., is either present or absent from the vehicle, with an associated dollars ($) differential effect).

At step 706, a linear dynamical system (LDS) model is created to express a state of the system for evaluating the fair market value of the vehicle. This step is further depicted in FIG. 6 by functional elements 603-605. The state of the model is preferably prepared as a vector of parameters (each expressed, for example, as dollars ($)/feature) for the vehicle. Numerical feature values are inherently expressed as being multiplicative and continuous, for example, as in $/mile*(value difference according to accumulated vehicle mileage) or dollars ($)/day*(value difference according to accumulated days between sales). Categorical feature values are inherently binary, are therefore are preferably prepared with discrete values (expressed, for example, as dollars ($)/color_white or dollars ($)/option_A). Thus, if two vehicles evaluated using the model share an identical binary feature, then there is no difference with respect to the feature, and therefore no contribution to a difference in valuation made by that feature.

For purposes of further illustrating principles of the present invention, an exemplary LDS model is now disclosed. The model is used to compute a fair market value V_{ab} for a vehicle “a” as compared to a value expressed by a recent sale of a vehicle “b” In this model, Fₐⱼ, indicates the value of a feature j with reference to the vehicle a, and xⱼ is a state variable providing a measure of an associated monetary value for the feature (dollars ($)/Fⱼ). The feature “vehicle value,” is set to 0 for vehicle “a”, while the vehicle value of “b” is set at an actual sale price for the vehicle “b.” The associated monetary value for feature “vehicle value” is fixed at 1. In this case, the model effectively makes corrections to the actual sale price of vehicle “b” based on the differences between features of the vehicles. Mathematically, the price is expressed as:

$${V}_{ab} = {\sum }_{∀ j} ( {F}_{{a}_{j}} - {F}_{{b}_{j}} ) {x}_{j} \qquad ( 6 )$$

At step 708 of the process 700 of FIG. 7, a “K nearest neighbor” (“K-NN”) analysis is performed to identify the K most similar vehicles to the vehicle “a” according to the recent past sales data (as depicted by functional elements 601 and 604 in FIG. 6). The analysis is preferably performed as follows. A distance metric, D_{ab}, measuring a level of difference between vehicle “a” and vehicle “b,” is defined as a sum of absolute value of the dollars ($) differences between the vehicles for each vehicle-specific feature (where the vehicle value is excluded), expressed as:

$${D}_{ab} = {\sum }_{∀ j \neq value} \vert ( {F}_{{a}_{j}} - {F}_{{b}_{j}} ) {x}_{j} \vert \qquad ( 7 )$$

Several related parameters may preferably be used in conjunction with the distance metric to select the K nearest neighbors. For example, a distance threshold (“Kmax”) may be empirically determined to ensure a reasonable distribution of similar vehicles are used in the pricing calculation, and applied so that those vehicles having a distance from vehicle “a” above the threshold Kmax are not considered. Alternatively, Kmax may be set to define a maximum number of vehicles, so that only the Kmax most similar vehicles are selected. Kmax may be determined empirically to be sufficiently large to ensure accurate calculations without requiring inordinate processing times. As yet another alternative, a minimum Kmin may be set (for example, at 8 vehicles) so that, if there are fewer than Kmin vehicles kept as a result of applying the distance threshold, then the distance threshold is ignored and the Kmin most similar vehicles are used as neighbors.

A unique and beneficial property of this model is that the distance metric is dynamic, because it is a function of current estimates xⱼ of the states of the system. As the estimates xⱼ over time provide increasingly accurate predictions for fair market value of specific vehicle attributes, the distance metrics used in the K-NN selection algorithm also improve to more accurately select the most similar vehicles to the vehicle “a,” thereby further “linearizing” the model as earlier described for improved accuracy.

Once the distances D_{ab} are computed, a weighted sum of K predicted values is prepared to calculate a fair market value Pₐ for the vehicle “a” (steps 710 and 712 of FIG. 2, and element 605 of FIG. 6) in comparison to each of the Kmax or Kmin most similar vehicles. The weighted sum may preferably be calculated by preparing weight w_{b} proportional to the inverse of the distance D_{ab}, to be applied to a comparative price V_{ab}, calculated for each vehicle “b” among the K most similar vehicles:

$${P}_{a} = {\sum }_{b = 1}^{K} {w}_{b} {V}_{ab} , where {w}_{b} ∝ \frac{1}{{D}_{ab}} \qquad ( 8 )$$

Specifically, the computation of W_{b} may take the following form:

$${α}_{b} = \frac{{\sum }_{b = 1}^{K} {D}_{ab}}{{D}_{ab}} , {w}_{b} = \frac{{α}_{b}}{{\sum }_{b = 1}^{K} {α}_{b}} \qquad ( 9 , 10 )$$

The fair market value Pₐ may then be used as an improved estimate of fair market value and a floor price for selling the vehicle “a” at auction.

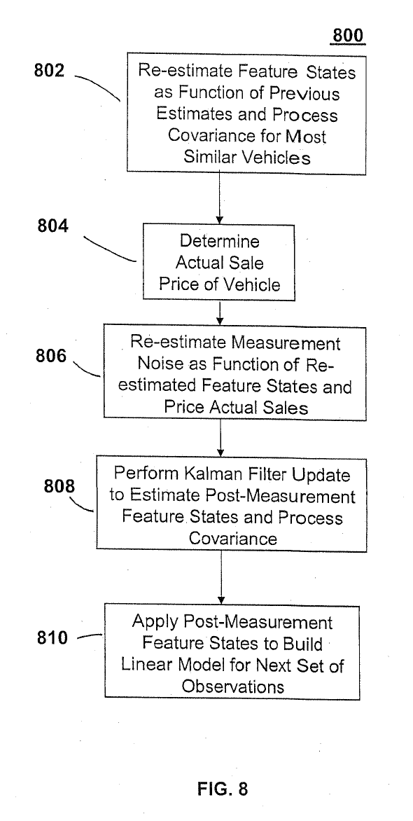

An exemplary process 800 for updating the model used to compute the fair market price according to the process 700 of FIG. 7 is further illustrated by a flow diagram of FIG. 8 and the schematic diagram of FIG. 6.

The process 800 of FIG. 8 operates to track and update the system states xⱼ, independently for each vehicle segment, by applying the Kalman filter equations that operate to produce an optimal unbiased estimate of the true value of the system state xⱼ. Kalman filters are well known in the art and described in, for example, in Kalman, R. E. (1960), “A new approach to linear filtering and prediction problems,” Transactions of the American Society for Mechanical Engineering, Series D, Journal of Basic Engineering 82, 35-45, which is incorporated by reference herein. With reference again to the process 700 of FIG. 7, it can be seen that the information pertaining to the K most similar vehicles is used first to estimate the state xⱼ for computing the fair market value Pₐ and then again in the process 800 of FIG. 8 to update the state xⱼ. Significantly, and as will be further illustrated below, this approach enables the Kalman filter to converge more rapidly toward an optimal estimate by more rapidly and accurately estimating the covariance of the process noise based only on vehicle information for the K most similar vehicles.

As step 802 of the process 800 depicted in FIG. 8 (and with reference to elements 603, 605 and 607 of FIG. 1), the states xₖ in view of a k^{th} set of observations are re-estimated as a function of previously estimated states xₖ₋₁ and a process noise vector wₖ₋₁. The process noise vector wₖ₋₁ is determined as a function of a process covariance Qₖ₋₁:

xₖ=xₖ₋₁+wₖ₋₁

zₐₖ=Fₐₖxₖ+vₖ (11, 12)

In this case, xₖ represents a vector of the parameter value states of the system in view of the k^{th} set of observations, and wₖ₋₁ represents a process noise vector, or state uncertainty, acting on the system state in view of a previous set of observations. The noise vector wₖ₋₁ is preferably modeled as normally distributed with zero mean and covariance (i.e., (wₖ₋₁˜N(0,Qₖ₋₁))). Qₖ is preferably constructed as a diagonal matrix, with each element qⱼₖ representing the “certainty” of the parameter xⱼₖ in the state. If qⱼₖ=0, then the certainty of the system state is 100%, so that the parameter xⱼₖ is unchanging. If qⱼₖ is non-zero, the system state is uncertain, at which point the Kalman filter update will adjust the system state for xⱼₖ in proportion to the uncertainty and error in the value measurement.

With reference to equation [12] above and steps 804, 806 of the process 800 of FIG. 8, zₐₖ represents a measured value vector of the desired car “a” at an iteration k (i.e., the actual price of the vehicle determined after its sale), where each element of the vector zₐₖ is the same (i.e. equals sale price). Fₐₖ represents a difference matrix, in which each row represents the distances between the features of car “a” and associated features of the K-NN selected vehicles, and vₖ represents the measurement noise on the actual sale price with mean zero and covariance R. In this case, the measurement noise represents an estimate of the inherent uncertainty of the price of a vehicle. It can be calculated as a variance of “similar” vehicle prices over time.

It should be noted that the difference matrix Fₐₖ need not be maintained at a single, fixed size, but may be reduced in size to include only those columns containing non-zero distance values with reference to the K-NN selected vehicles. This reduction serves to prevent the formation of a rank-deficient matrix as would occur with a “zero column,” and reduces associated processing and computation efforts required. As Applicants' experience suggests that the difference matrix Fₐₖ prior to such reduction in practice may be quite large and quite sparse, the benefits from size reduction are often significant.

R may be defined as a diagonal matrix, where each diagonal element of R represents a measure of the certainty with which the measured sale price reflects the true value of the vehicle. Typically, the matrix R is defined as R=rI, so that the sale of car “a” has the same uncertainty for all its K-NN comparisons. In the present example, “r” may be set to r=1000.

At steps 808 and 810 of FIG. 8 (and with reference to element 606 of FIG. 6), standard Kalman filter update equations are applied to update the linear equations (equations [6]-[10]) in view of the parameter states xₖ. The update equations are independently applied, for example, to each of the identified segments of the vehicle population. The standard Kalman update equations are (the index to vehicle “a” is dropped):

Pₖ⁻=Pₖ₋₁+Qₖ

Kₖ=Pₖ⁻Fₖ^{T}(FₖPₖ⁻Fₖ^{T}+Rₖ)⁻¹

xₖ^{new}=xₖ+Kₖ(zₖ−Fₖxₖ)

Pₖ=(I−KₖFₖ)Pₖ⁻ (13-16)

where:

Pₖ⁻ represents an estimated process covariance for the k^{th} set of observations,

Kₖ represents an optimal Kalman gain for the k^{th} set of observations,

Fₖ^{T} is a transverse matrix corresponding to the difference matrix Fₖ for the k^{th} set of observations,

Xₖ^{new} represents the updated state estimate based on the k^{th} set of observations, and

Pₖ represents the updated process covariance estimate based on the k^{th} set of observations.

Xₖ^{new} is may then be used as the current state estimate for calculating the floor price for a next vehicle to be sold in an associated vehicle segment.

Implementation of Method for Setting Floor Price

The disclosed method for developing the accounts collection program is particularly suitable for implementation using a computer or computer system as described in more detail below.

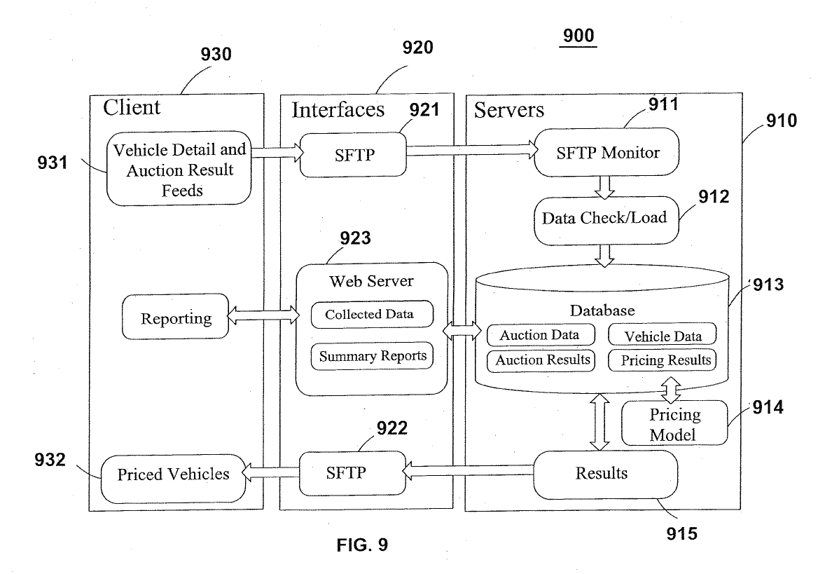

FIG. 9 shows a schematic diagram illustrating a system 900 suitable for implementing the present invention. The system 900 includes a server component 910 that interacts with client devices 930 via an interface component 920. In the system 900, vehicle data 931 including auction sales data (for example, actual sales prices) are fed by a client device 930 in an encrypted form over a secure FTP (SFTP) link 921 to a SFTP monitor 911 of a server component 910. The SFTP monitor 911 detects the arrival of the data, and decrypts and forwards the data to a data check/load component 912, which verifies the decrypted data and loads the verified data into a database 913. The database 913 may be structured, for example, to store general auction data, data relating to auction results, data pertaining to auctioned vehicles and data pertaining to the pricing models constructed according to the description provided herein. A pricing model 914, for example as previously described herein, is executed by the server component 910 to retrieve associated data from the database 913, calculate fair market value prices for vehicles at auction, and to store calculated fair market prices in the database 913. A results component 915 is configured to retrieve auction and pricing results from the database 913 (including calculated fair market prices), and to communicate this data over a SFTP link 922 to a prices vehicles storage component 932 of the client device 930.

In addition, one or more web servers 923 may be provided as part of the interface component 920 to access data from the database 913 and prepare summary reports for display on one of the client devices 930.

At this point, while we have presented this disclosure using some specific examples, those skilled in the art will recognize that our teachings are not so limited. Accordingly, this disclosure should be only limited by the scope of the claims attached hereto.

We claim:

1. A computer-implemented method for allocating items to be sold at auction among a plurality of auction sites, the method performed on a server computer and comprising steps of:
a. providing an inventory database storing information uniquely identifying a plurality of items and associating each of said items with a one of the plurality of available auction sites or a holding site as a current location;
b. providing a constraints database storing a first set of allocation constraints;
c. identifying for each of said items one or more of said available auction sites to which said item is available to be moved from its current location;
d. determining for each of said items an estimated profit value to be realized from each available move;
e. selecting an available move for one of said items that has a highest estimated profit value above a threshold value among available moves that are feasible under the set of allocation constraints;
f. re-estimating the estimated profit value for the remaining available moves of other ones of said items;
g. repeating steps e. and f. while the available moves for the other ones of said items have an estimated profit value above the threshold value and are feasible under the first set of allocation constraints;
h. allocating each of said items having a selected move to its associated location among the plurality of available auction sites and the holding site ; and
i. transmitting the identification information for each item having a selected move together with information identifying its associated allocated location to a client device.

2. The computer-implemented method of claim 1, wherein the items comprise vehicles.

3. The computer-implemented method of claim 2, wherein the vehicles comprise automobiles.

4. The computer-implemented method of claim 1, wherein the items comprise industrial equipment.

5. The computer-implemented method of claim 1, further comprising the step of storing the identification information for each item and its associated location in an allocation database.

6. The computer-implemented method of claim 1, wherein the step of determining an estimated profit value from an available move further comprises the steps of:
estimating a sales price for one of said items at its current location;
estimating a sales price for said item at the auction site of the available move;
estimating a shipping cost for moving said item from its current location to the auction site of the available move; and
calculating the estimated profit value as the estimated sales price at the auction site of the available move less the estimated sales price at the current location and the estimated cost of moving said item from the current location to the auction site of the available move.

7. The computer-implemented method of claim 6, wherein the shipping cost is estimated as a function of a shipping distance for the available move and at least one of a size or weight of said item.

8. The computer-implemented method of claim 1, wherein the step of estimating a sales price of an item at an auction site further comprises the steps of:
estimating an expected sales date for the item; and
estimating the sales price as a function of the sales date.

9. The computer-implemented method of claim 8, wherein the expected sales date is determined as a function of a waiting time estimated as a function of the number of items at the auction site and an expected shipping time from the current location to the auction site of the available move.

10. The computer-implemented method of claim 8, wherein the sales price is adjusted as a function of estimated depreciation.

11. The computer-implemented method of claim 10, wherein depreciation is estimated as a function of an estimated cost of capital.

12. The computer-implemented method of claim 8, wherein the sales price is adjusted as a function of a seasonality function.

13. The computer-implemented method of claim 8, wherein the sales price is adjusted as a function of price elasticity.

14. The computer-implemented method of claim 1, wherein the first set of allocation constraints specifies a maximum allowable number of items for each of the available auction sites.

15. The computer-implemented method of claim 14, further comprising the step of:
storing a second set of constraints in the constraints database;
determining whether the selected moves of steps e.-g. are feasible under the second set of constraints; and
repeating steps e.-g. while ones of said items have available moves having an estimated profit value above the threshold value until the selected moves are feasible under the second set of constraints.

16. The computer-implemented method of claim 15, wherein the second set of allocation constraints specifies a minimum allowable number of items for each of the available auction sites.

17. A computer program product, comprising a non-transitory computer-usable storage medium having computer-readable instructions embodied therein, the computer-readable instructions adapted to be executed by a server to implement a method for allocating items to be sold at auction among auction sites comprising the steps of:
a. storing information uniquely identifying a plurality of items in an inventory database, and associating each of said items with a current of a plurality of available auction sites or a holding site as a current location;
b. storing a first set of allocation constraints in a constraints database ;
c. identifying for each of said items one or more of said available auction sites to which said item is available to be moved from its current location;
d. determining for each of said items an estimated profit value to be realized from each available move;
e. selecting an available move for one of said items that have a highest estimated profit value above a threshold value among available moves that are feasible under the set of allocation constraints;
f. re-estimating the estimated profit value for the remaining available moves of other ones of said items;
g. repeating steps e. and f. while the available moves for the other ones of said items have an estimated profit value above the threshold value and are feasible under the first set of allocation constraints;
h. allocating each of said items having a selected move to its associated location among the plurality of available auction sites and the holding site ; and
i. transmitting the identification information for each item having a selected move together with information identifying its associated allocated location over a secure link to a client device.

18. The computer program product of claim 17, wherein the items comprise vehicles.

19. The computer program product of claim 18, wherein the vehicles comprise automobiles.

20. The computer program product of claim 17, wherein the items comprise industrial equipment.

21. The computer program product of claim 17, further comprising instructions for implementing the step of storing the identification information for each item and the allocated auction site in an allocation database.

22. The computer program product of claim 17, wherein the step of determining an estimated profit value from an available move further comprises the steps of
estimating a sales price for one of said items at its current location;
estimating a sales price said item at the auction site of the available move;
estimating a shipping cost for moving said item to from the current location to the auction site of the available move; and
calculating the estimated profit value as the estimated sales price at the auction site of the available move less the estimated sales price at the current location and the estimated cost of moving said item from the current location to the auction site of the available move.

23. The computer program product of claim 22, wherein the shipping cost is estimated as a function of a shipping distance for the available move and at least one of a size or weight of said item.

24. The computer program product of claim 17, wherein the step of estimating a sales price of an item at an auction location further comprises the steps of:
estimating an expected sales date for the item; and
estimating the sales price as a function of the sales date.

25. The computer program product of claim 24, wherein the expected sales date is determined as a function of a waiting time estimated as a function of the number of items at the auction site and an expected shipping time from the original location to the auction site of the available move.

26. The computer program product of claim 24, wherein the sales price is adjusted as a function of estimated depreciation.

27. The computer-implemented method of claim 17, wherein the first set of allocation constraints specifies a maximum allowable number of items for each of the available auction sites.

28. The computer-implemented method of claim 27, further comprising the step of:
storing a second set of constraints in the constraints database;
determining whether the selected moves of steps e.-g. are feasible under the second set of constraints; and
repeating steps e.-g. while ones of said items have available moves having an estimated profit value above the threshold value until the selected moves are feasible under the second set of constraints.

29. The computer-implemented method of claim 28, wherein the second set of allocation constraints specifies a minimum allowable number of items for each of the available auction sites.

30. A computer-implemented method for allocating one or more items to be sold at auction to one or more auction sites, the method comprising:
storing information uniquely identifying the one or more items associated with the one or more auction sites;
storing a first set of constraints;
determining estimated profits obtained by moving the one or more items among the one or more auction sites, subject to the constraints;
selecting ones of the moves for ones of the one or more items having a highest estimated profit value above a threshold value;
allocating the one or more items among the one or more auction sites according to the selected moves; and
transmitting information uniquely identifying the one or more items and the allocated auction sites to a client device.

31. The method of claim 30, wherein the determining step comprises the steps of:
estimating an origin sales price for the one or more items at the one or more auction sites;
estimating a destination sales price for the one or more items at the one or more auction sites different than used in estimating the origin sales price;
estimating a shipping cost for the one or more items in moving the items from one location to another locations; and
determining the estimated profit as a function of the origin sales price, the destination sales price and shipping cost.

32. The method of claim 30, wherein the destination sales price is determined as a function of an initial price, a depreciation factor and a seasonability factor.

33. The method of claim 30, wherein the destination sales price is also determined as a function of a price elasticity.
